(19) United States
(12) Patent Application Publication
(10) Pub. No.: US 2017/0318143 A1
(43) Pub. Date: Nov. 2, 2017

(54) MONITORING AND PREVENTING COMMUNICATIONS BETWEEN INMATES

(71) Applicant: GLOBAL TEL*LINK CORP., Reston, VA (US)

(72) Inventor: Stephen L. HODGE, Aubrey, TX (US)

(21) Appl. No.: 15/139,904

(22) Filed: Apr. 27, 2016

(51) Int. Cl. H04M 1/67; H04M 3/22; H04M 3/42; H04B 11/00

(52) U.S. Cl. CPC H04M 1/67; H04M 3/42068; H04B 11/00; H04M 3/2218; H04M 3/2281

(57) ABSTRACT

Systems and methods are disclosed for monitoring communications between inmates at controlled facilities. In an embodiment request is first received to initiate a call involving an inmate at a controlled facility. The identity of the inmate may then be authenticated, and the call may be connected to an outside third party upon successful authentication. A tone encoded with source information of the call may be generated and intermittently transmitted while the call is active. The inmate's received call data may then be monitored to detect a second tone. Source information encoded within the second tone may be extracted and compared with call data stored in a call database to determine whether the extracted source information corresponds to a second inmate at a controlled facility. Finally, an alert may be sent to relevant parties when it is determined that the extracted source information corresponds to the second inmate.

### BACKGROUND

### Field

Embodiments described herein are generally related to monitoring and preventing communications between inmates in controlled environments.

### Background

Inmates in controlled environments, such as correctional facilities, are commonly permitted to communicate with parties inside and outside of the controlled environment using the facility's communication system. For example, inmates may place audio or video calls using a facility telephone or other device to authorized parties. However, inmates are normally restricted from calling other inmates within a controlled environment.

Facilities within controlled environments often employ call processing and monitoring systems to regulate incoming and outgoing communications. These systems are designed to ensure that only authorized communications occur, but the ability of inmates to communicate with other inmates presents a number of challenges that are unique to controlled environments and not adequately addressed by existing monitoring and control systems.

### SUMMARY

Systems and methods are disclosed for monitoring communications between inmates at controlled facilities. In an embodiment request is first received to initiate a call involving an inmate at a controlled facility. The identity of the inmate is then authenticated, and the call is connected to a third party outside of the controlled facility upon successful authentication. A tone encoded with source information of the call is generated and intermittently transmitted while the call is active.

Once active, the inmate's received call data is monitored to detect a second tone. Source information encoded within the second tone is then extracted and compared with call data stored in a call database to determine whether the extracted source information corresponds to a second inmate at a controlled facility. Finally, an alert is sent to relevant parties when it is determined that the extracted source information corresponds to the second inmate.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art(s) to make and use the disclosure.

FIG. 1 is a diagram illustrating an example call processing system for monitoring and preventing communications between inmates in controlled environments, according to an embodiment.

FIG. 2 is a diagram illustrating an example distributed call processing system for monitoring and preventing communications between inmates in controlled environments, according to an embodiment.

FIG. 3 is an example method for monitoring communications between inmates at controlled facilities, according to an embodiment.

FIG. 4 is an example method for detecting a communication between inmates at controlled facilities, according to an embodiment.

FIG. 5 is a diagram illustrating an example computing device, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

In the detailed description that follows, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to include such feature, structure, or characteristic in connection with other embodiments whether or not explicitly described.

The embodiments described herein are provided for illustrative purposes, and are not limiting. Other embodiments are possible, and modifications may be made to the described embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer, as described below.

For purposes of this discussion, the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description will so fully reveal the general nature of the invention that others can, by applying knowledge of those skilled in relevant art(s), readily modify and/or adapt for various applications described embodiments, without undue experimentation, without departing from the spirit and scope of the disclosure. Therefore, such adaptations and modifications are intended to be within the meaning and plurality of equivalents of the described embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Those skilled in the relevant art(s) will recognize that this description may be applicable to many various charging and/or communication methods without departing from the spirit and scope of the present disclosure.

### Example Call Processing System

Correctional facilities and other controlled environments often allow limited communication between resident inmates and other parties. However, inmates are generally restricted from placing audio or video calls to other inmates, as this communication may be used to coordinate and facilitate illegal activity.

Communication is often restricted through use of facility communication systems by designating permitted calling times, authorizing numbers and parties that may be called, and authenticating calling parties. Most inmate communications are closely monitored, and often recorded, to ensure compliance with facility rules and regulations. Thus, facility communication systems must be robust enough to detect and enforce inmate communication violations that occur.

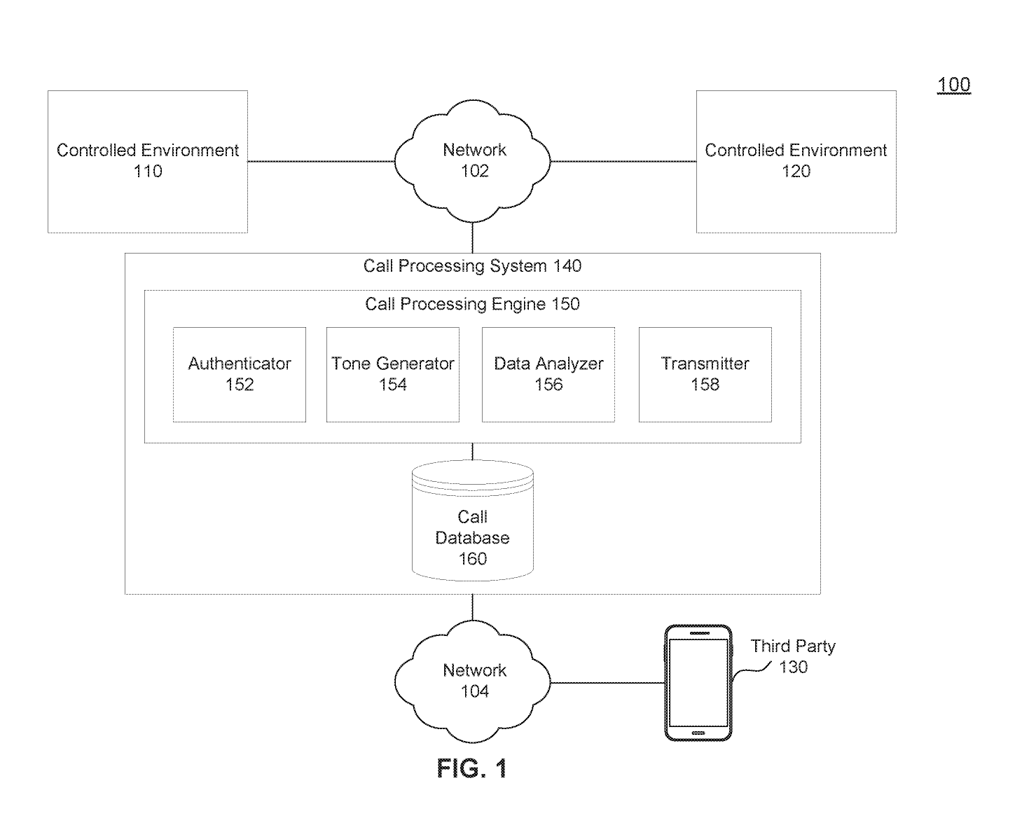

FIG. 1 is a diagram 100 illustrating an example call processing system for monitoring and preventing communications between inmates in control led environments, according to an embodiment. FIG. 1 illustrates controlled environments 110 and 120 coupled to call processing system 140 via network 102. Call processing system 140 is further coupled to a third party 130 via network 104. Networks 102 and 104 may each be any type of network capable of communicating data, for example, a local area network, a wide-area network (e.g., the Internet), public switched telephone network (PSTN), or any combination thereof. Controlled environments 110 and 120 may include any types of controlled facilities, such as but not limited to, correctional facilities (e.g., prisons, jails), psychiatric hospitals, or other controlled institutions. In various embodiments, networks 102 and 104 may represent the same or different networks. For example, network 102 may represent a private network connecting controlled environments 110 and 120 and call processing system 140, while network 104 may connect call processing system 140 to outside call parties, such as third party 130.

Controlled environments 110 and 120 include various communication devices that allow inmates to place audio and/or video calls to outside parties. These communication devices may include, for example, communication kiosks, facility telephones, and wireless devices (e.g., wireless phones and tablet devices). These devices may he hardwired or wirelessly connected to local facility networks and communication management systems. In an embodiment, communications from analog devices within controlled environments 110 and 120 are converted to a digital signal by an internet access device (IAD) to make use of employed Voice over Internet Protocol (VoIP) services.

In an embodiment, when an inmate places an audio or video call from correctional environment 110 or 120, the call is first routed to call processing system 140 before being connected to another call party. Call processing system 140 includes call processing engine 150 and call database 160. Call database 160 stores call data related to calls processed by call processing system 140. In an embodiment, call database 160 stores information related to the inmate involved in a call, the communication device used by the inmate, the facility where the call is connected, and whether the call is an incoming or outgoing call from the facility. For certain calls, the call database also stores recorded video or audio of the call. Call database 160 may be any type of structured data store, including a relational or document-oriented database.

Call processing engine 150 includes authenticator 152, tone generator 154, data analyzer 156, and transmitter 158. In an embodiment, authenticator 152 receives requests to initiate a call between an inmate and a third party. For example, an inmate within correctional environment 110 may place a call to third party 130. When the call request is received, authenticator 152 authenticates the identity of the inmate before connecting the call between the inmate and third party 130. In various embodiments, authentication methods may include any combination of, without limitation, voice recognition, video/facial recognition, fingerprinting, and other biometrics. In an embodiment, authenticator 152 also verifies the inmate's communication privileges to ensure that the inmate is authorized to call third party 130. Upon successful authentication, authenticator 152 connects the call to third party 130.

While the inmate within controlled environment 110 may be authorized to communicate with third party 130, inmates are generally restricted from communicating with another inmate within a controlled environment. Inmates might attempt to circumvent this restriction by contacting a common intermediary who can connect the inmates together through a bridge. For example, an inmate within controlled environment 110 and an inmate within controlled environment 120 might both place a call to third party 130. Third party 130 may be using a device with a conference feature, who then conferences the two inmates together. In another example, an inmate within controlled environment 110 might first call third party 130. If controlled environment 120 allows inmates to receive calls, third party 130 may use a three-way calling feature to call an inmate within controlled environment 120, connecting the two inmates. Further complexity is added if the two inmates place calls to different phone numbers or call parties that each correspond or redirect to third party intermediary 130.

In order to address these and similar scenarios, call processing engine 150 includes tone generator 154. In an embodiment, tone generator 154 generates a frequency modulated tone encoded with call source information. Source information may include, for example, the identity of the inmate involved in the call and the controlled facility from which the call is connected. When a call between an inmate and third party 130 is connected, transmitter 158 transmits the generated tone to third party 130 while the call is active.

In an embodiment, the generated tone is transmitted as short beeps or embedded in notices played at the beginning of the call, as will be described further below. For example, when the call is connected, notices are commonly played to inform third party 130 that the call is from a controlled facility and provide information about the inmate and/or facility. For instance, the following notices might be played following connection of the call to third party 130: “You have a collect call from John Smith, an inmate at ABC correctional center.” In an embodiment, the notices further indicate that the call is being recorded. In an embodiment, short, audible beeps are also played during the call at determined time intervals to indicate that the call is from a controlled environment and/or that the call is being recorded. In this manner, call source information can be embedded in the notices and/or beeps.

In an embodiment, call database 160 includes reference information related to inmates and other known call parties, facilities, and communication devices/equipment. This information may include, for example, names, locations, and unique alphanumeric identifiers (e.g., “1234” or “A1234”) for each inmate and controlled environment facility. In an embodiment, call database 160 also stores a unique alphanumeric identifier corresponding to the call. For example, an incremental sequence number can be generated for each call and stored in call database 160. In an embodiment, the unique call identifier is linked to other reference information, such as parties, facilities, and communication devices involved in the call. These unique identifiers can further act as primary keys to identify tuples within call database 160.

To generate the tone, according to an embodiment, tone generator 154 first retrieves identifiers from call database 160 for the inmate and facility involved in the call. These identifiers can be used to identify source information of the call. Tone generator 154 then generates a code sequence representing the retrieved inmate and facility identifiers. In an embodiment, the code sequence includes a sequence of digits that incorporates the retrieved inmate and facility identifiers. The identifiers may be incorporated into a code sequence by concatenating the identifiers (e.g., appending the inmate identifier to the facility identifier, or the reverse). In various embodiments, the inmate and facility identifiers can be incorporated in the same format that they are stored in call database 160, converted to a binary representation, or transformed into another fixed length digit sequence. For example, the code sequence may include ten digits that are allocated and partitioned such that the first six digits represent the inmate and the last four digits represent the facility. In an embodiment, these digit representations can be decoded by analyzer 156 and correlated to the reference information stored in call database 160.

In an embodiment, to generate the tone, tone generator 154 alternatively retrieves the unique identifier for the call from call database 160. The call identifier may be incorporated into a code sequence in the same format stored in call database 160, by converting the call identifier to binary representation, or by transforming the call identifier into another fixed length digit sequence. This approach may reduce the length of the code sequence needed to represent the call source information. One of skill in the art will further recognize that, in addition to the discussed embodiments, the generated code sequence may take on any logical form that can represent source information of the call.

After generating the code sequence, tone generator 154 modulates the frequency of a tone to embed the code sequence. In an embodiment, tone generator 154 starts with a base pure tone having a particular carrier frequency. The modulation occurs in relation to the carrier frequency, and different controlled environments may use the same or different carrier frequencies. For example, if the carrier frequency is 1500 Hz, tone generator 154 can modulate the frequency of the tone between 1450 Hz and 1550 Hz to embed the generated code sequence.

When a call is connected to an outside calling party, such as third party 130, transmitter 158 transmits the generated tone to the outside calling party. In an embodiment, the tone is transmitted as part of the call audio. In an embodiment, the tone is played as a short beep (e.g., a one second beep) that is noticeably audible to the outside calling party, although low enough in volume as to not interfere with conversation audio. The audible tone ensures that the outside calling party is aware that the call is being monitored and may act as a deterrent for facilitating communication between inmates. In another embodiment, the tone is transmitted and played simultaneously with notices at the beginning of a call, at a volume low enough as not to distort the notices. Additionally, no audio filters are needed to filter out the tone before forwarding to the outside calling party, reducing overall complexity.

In an embodiment, transmitter 158 intermittently transmits the generated tone at random time intervals while the call is active. The randomization of transmission intervals ensures that calling parties cannot time calls based on known intervals. For example, if parties had knowledge that the tone was not transmitted until 30 seconds after call connection, the parties could time the call to last for less than 30 seconds. Similarly, if parties had knowledge of a predefined tone length and regular time interval, the outside calling party could mute the audio at appropriate times to avoid forwarding a tone to an inmate. These avoidance methods may be prevented by randomizing the intervals in which the generated tone is transmitted.

Many controlled facilities make use of Voice over Internet Protocol (VoIP) for calls between inmates and outside parties to reduce overall communication costs. VoIP services traditionally maximize bandwidth by allocating bandwidth to speaking parties. For instance, when one party is silent, all available bandwidth may be allocated to the other party that is speaking. This minimizes data usage by only sending voice data in one direction at a time. That is, no voice data needs to be transmitted from the silent call party until that party begins speaking, leaving additional bandwidth to allocate to the speaking party. By transmitting the generated tone intermittently, rather than continuously, controlled facilities can take advantage of VoIP bandwidth allocation to reduce overall costs.

Once a call involving an inmate has been connected, according to an embodiment, data analyzer 156 monitors incoming (received) data for the inmate. For example, a call may be connected from an inmate at controlled environment 110 to third party 130. In an embodiment, data analyzer 156 has access to both outgoing (sent) and incoming (received) call data of the inmate. Because transmitter 158 transmits a generated tone to third party 130 during the call, as described previously, the tone can be detected in the inmate's outgoing call data. However, a similar tone detected in the inmate's incoming call data may indicate that the inmate is actually connected to another inmate, such as an inmate residing within controlled environment 120.

In an embodiment, data analyzer 156 inspects the inmate's incoming call data to determine whether a second modulated tone is present. As previously described, the tone transmitted by transmitter 158 should appear in the inmate's outgoing call data. However, a modulated tone detected in the inmate's incoming call data indicates a possible inmate-to-inmate communication. Data analyzer 156 includes a combination of hardware and software components capable of detecting audio tones and frequencies generated by tone generator 154. If a second modulated tone is present in the inmate's incoming call data, data analyzer 156 extracts source information encoded in the tone to identify the source of the tone. As described previously, the extracted source information may be in the form of a code sequence that has been embedded in the second tone.

In an embodiment, analyzer 156 then compares the extracted source information to data stored in call database 160 to determine whether the extracted source information corresponds to a second inmate at a controlled facility. For example, if the extracted source information is in the form of a partitioned code sequence representing an inmate and facility, analyzer 156 can query the respective codes in call database 160 to retrieve inmate and facility information. Similarly, if the extracted source information is in the form of a unique sequence number, analyzer 156 can query call database 160 to retrieve information about the inmate and facility to which the call in connected.

If data analyzer 156 determines that the extracted source information, and thus the detected tone, corresponds to a second inmate, data analyzer 156 can take action to address the issue. In an embodiment, data analyzer sends an alert that an inmate-to-inmate communication has been discovered. This alert is sent to relevant parties, for example administrators and authorities at controlled environments 110 and 120. The alert may include information about the inmates, facilities, and other parties involved in the call so that appropriate action can be taken. In another embodiment, data analyzer 156 may issue an audible warning on the call, for example a voice announcement or audible tone, to inform the call parties that a prohibited communication has been detected. In other various embodiments, data analyzer 156 may end the communication between parties, flag the call in call database 160, flag the phone numbers and/or third party involved in the communication, or flag the inmates involved in the communication. In an embodiment, flagged numbers, parties, and inmates are used by call processing system 140 to modify communication permissions and detect future communications that are prohibited. Data analyzer 156 may implement any combination of the above-described embodiments to address detected inmate-to-inmate communications.

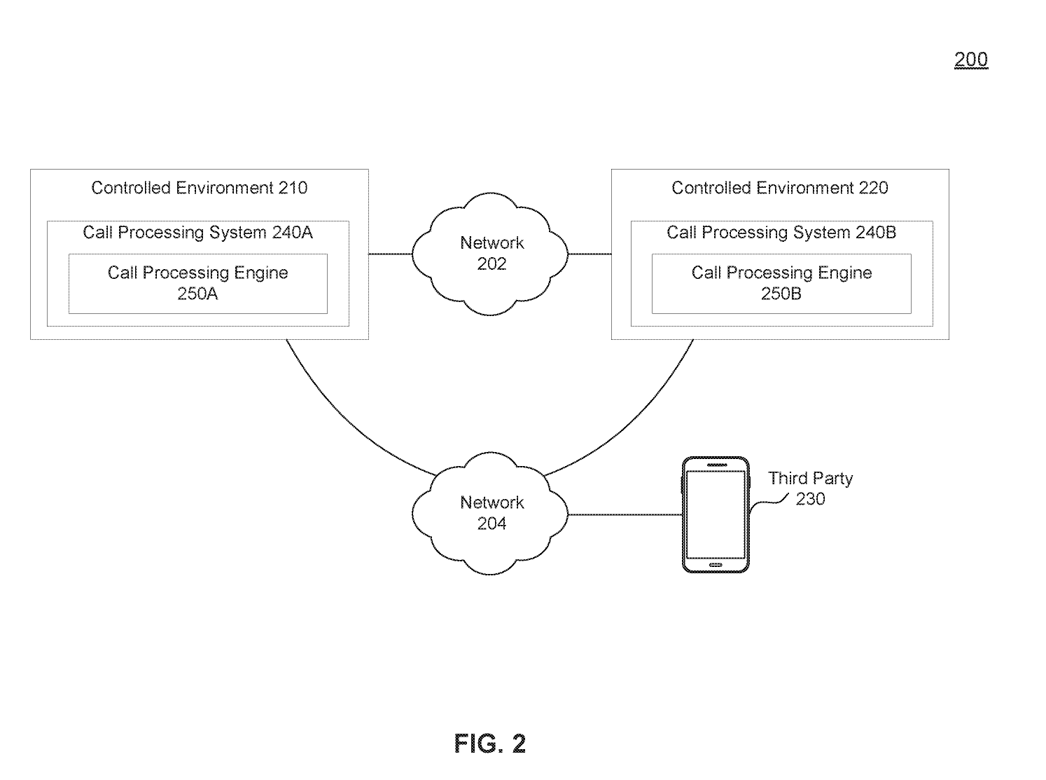

FIG. 2 is a diagram 200 illustrating an example distributed call processing system for monitoring and preventing communications between inmates in controlled environments, according to an embodiment. FIG. 2 illustrates controlled environments 210 and 220 coupled via network 102 and further coupled to third party 230 via network 204. Networks 202 and 204 may each be any type of network capable of communicating data, for example, a local area network, a wide-area network (e.g., the Internet), public switched telephone network (PSTN), or any combination thereof. Controlled environments 210 and 220 may include any types of controlled facilities, such as but not limited to, correctional facilities (e.g., prisons, jails), psychiatric hospitals, or other controlled institutions. In various embodiments, networks 202 and 204 may represent the same or different networks. For example, network 202 may represent a private network connecting controlled environments 210 and 220, while network 204 may connect controlled environments 210 and 220 to outside call parties, such as third party 230.

Controlled environment 210 includes call processing system 240A, which includes call processing engine 250A, and controlled environment 220 includes call processing system 240B, which includes call processing engine 250B. Call processing systems 240A and 240B reside locally within controlled environments 210 and 220, respectively. In an embodiment, call processing systems 240A and 240B and call processing engines 250A and 250B operate similar to call processing system 140 and call processing engine 150 of FIG. 1, respectively. In this manner, FIG. 2 illustrates a distributed call processing system that performs processing locally within each controlled environment.

In an embodiment, call processing systems 240A and 240B are coupled to a centralized call database, such as call database 160 of FIG. 1, via network 202. This enables access to data shared by multiple controlled environments while reducing data replication and synchronization requirements. Alternatively, call processing systems 240A and 240B may each include a local call database. In this embodiment, each call processing system can periodically execute synchronization processes to ensure each database contains current data. In a further embodiment, both a centralized and local call databases are employed, storing data shared among controlled environments in the centralized database. This embodiment allows fast access to locally stored data while reducing synchronization requirements.

### Example Method

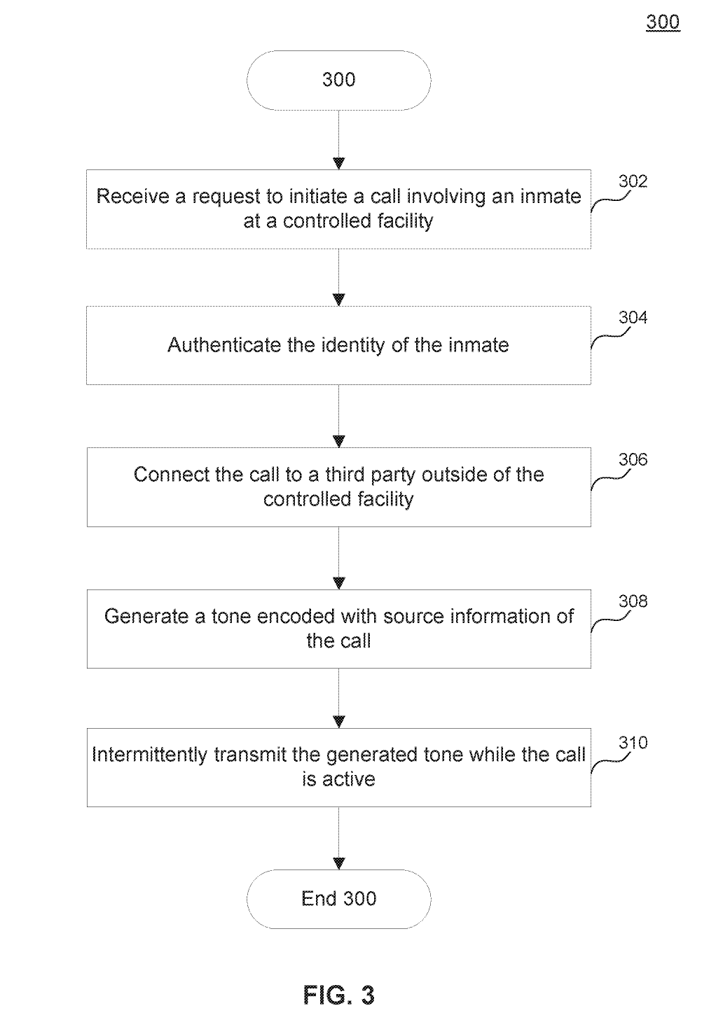

FIG. 3 is an example method 300 for monitoring communications between inmates at controlled facilities, according to an embodiment. The method 300 will be described below with reference to FIGS. 1 and 2.

Method 300 begins at stage 302 when a request is received to initiate a call involving a first inmate at a controlled facility. This request may be initiated by the inmate, or if the facility allows incoming calls to inmates, the request may be initiated by an outside party, such as third party 130 of FIG. 1. In an embodiment, the request is received by a call processing system, such as call processing system 140 of FIG. 1.

At stage 304, the identity of the inmate is authenticated before connecting the call. In various embodiments, authentication methods may include any combination of, without limitation, voice recognition, video/facial recognition, fingerprinting, and other biometrics. In an embodiment, the inmate's communication privileges are also verified to ensure that the inmate is authorized to call the other party involved in the call. Authentication may be performed by an authenticator, such as authenticator 152 of FIG. 1.

At stage 306, the call is connected to a third party outside of the controlled facility upon successful authentication. At stage 308, a modulated tone encoded with source information of the call is generated. Source information may include, for example, the identity of the inmate involved in the call and the controlled facility from which the call is connected. The tone may be generated by a tone generator, such as tone generator 154 of FIG. 1.

In an embodiment, to generate the tone, identifiers for the inmate and facility involved in the call are first retrieved from a call database, such as call database 160 of FIG. 1. These identifiers can be used to identify source information of the call stored in the call database. A code sequence representing the retrieved inmate and facility identifiers is then generated. In an embodiment, the code sequence includes a sequence of digits that incorporates the retrieved inmate and facility identifiers. The identifiers may be incorporated into a code sequence by concatenating the identifiers (e.g., appending the inmate identifier to the facility identifier, or the reverse). In various embodiments, the inmate and facility identifiers can be incorporated in the same format that they are stored in call database 160, converted to a binary representation, or transformed into another fixed length digit sequence. For example, the code sequence might include ten digits that are allocated and partitioned such that the first six digits represent the inmate and the last four digits represent the facility. In an embodiment, these digit representations can be decoded and correlated to the call source information stored in the call database.

In an embodiment, to generate the tone, a unique identifier for the call is alternatively retrieved from the call database. The call identifier may be incorporated into a code sequence in the same format stored in the call database, by converting the call identifier to binary representation, or by transforming the call identifier into another fixed length digit sequence. This approach may reduce the length of the code sequence needed to represent the call source information. One of skill in the art will further recognize that, in addition to the discussed embodiments, the generated code sequence may take on any logical form that can represent source information of the call.

After generating the code sequence, the frequency of the tone is modulated to embed the code sequence. In an embodiment, a base pure tone having a particular carrier frequency is first generated. The modulation occurs in relation to the carrier frequency, and different controlled environments may use the same or different carrier frequencies. For example, if the carrier frequency is 1500 Hz, the frequency of the tone can be modulated between 1450 Hz and 1550 Hz to embed the generated code sequence.

At stage 310, the generated tone is intermittently transmitted as part of the call audio while the call is active. The tone may be transmitted by a transmitter, such as transmitter 158 of FIG. 1. In an embodiment, the generated tone is transmitted as short beeps and/or simultaneously with notices played at the beginning of the call. For example, when the call is connected, notices are commonly played to inform the third party that the call is from a controlled facility and provide information about the inmate and/or facility. The notices may further indicate that the call is being recorded. In an embodiment, short-duration (e.g., one second), audible beeps are also played during the call at determined time intervals to indicate that the call is from a controlled environment and/or that the call is being recorded. In this manner, call source information can be encoded in the notices and/or beeps.

In an embodiment, the generated tone is intermittently transmitted at random time intervals while the call is active. The randomization of transmission intervals ensures that calling parties cannot time calls based on known intervals, for example by limiting call length or periodically muting audio to avoid transmitting the generated tone to another inmate.

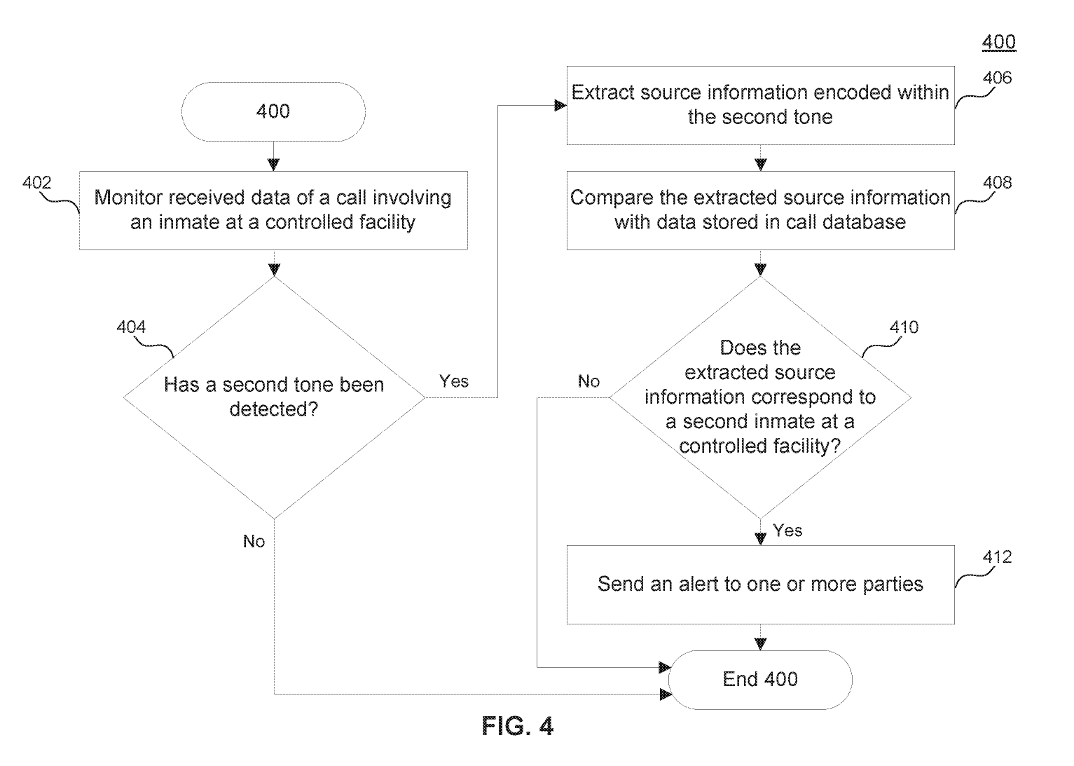

FIG. 4 is an example method 400 for detecting a communication between inmates at controlled facilities, according to an embodiment. Method 400 begins at stage 402 by monitoring received data of a call involving a first inmate at a first controlled facility. As previously described, transmitted tones, for example the tone transmitted at stage 310 of method 300, should appear in the inmate's transmitted call data. However, a modulated tone detected in the inmate's received call data indicates a possible inmate-to-inmate communication. Monitoring may be performed by a data analyzer, such as data analyzer 156 of FIG. 1.

At stage 404, a determination is made whether a modulated tone has been detected from the received data of the call. That is, the inmate's received call data is inspected to determine whether a modulated tone is present. A tone detected in the inmate's received call data may indicate that the inmate is actually connected to another inmate, which is generally restricted by controlled facilities. If a modulated tone is detected, the method proceeds to stage 406. Otherwise, the method ends.

At stage 406, source information encoded within the second tone is extracted to identify the source of the tone. As described previously, the extracted source information may be in the form of a code sequence that has been encoded in the modulated tone.

At stage 408 the extracted source information is compared with data stored in a call database, such as call database 160 of FIG. 1, to determine whether the extracted source information corresponds to a second inmate at the first controlled facility or a second controlled facility. For example, if the extracted source information is in the form of a partitioned code sequence representing an inmate and facility, the call database can be queried for the respective codes to retrieve inmate and facility information. Similarly, if the extracted source information is in the form of a unique sequence number, the call database can be queried to retrieve information about the inmate and facility to which the call in connected. At stage 410, if it is determined that the extracted source information corresponds to a second inmate, the method proceeds to stage 412. If not, the method ends.

Finally, at stage 412, an alert is sent to one or more parties to indicate that an inmate-to-inmate communication has been detected. This alert is sent to relevant parties, for example administrators and authorities at controlled facilities involved in the call. In an embodiment, the alert includes information about the inmates, facilities, and other parties involved in the call so that appropriate action can be taken. In an embodiment, stages 402-412 are repeated while the call remains active for continuous monitoring purposes. In various embodiments, other actions may be taken in addition or as an alternative to sending an alert. For example, an audible warning may be issued on the call to inform the call parties that a prohibited communication has been detected. In other various embodiments, the communication may be ended, or the call, inmates, phone numbers, and/or third party involved in the communication may be flagged in the call database. In an embodiment, flagged numbers, parties, and inmates are used to modify communication permissions and detect future communications that are prohibited.

### Example Computer System

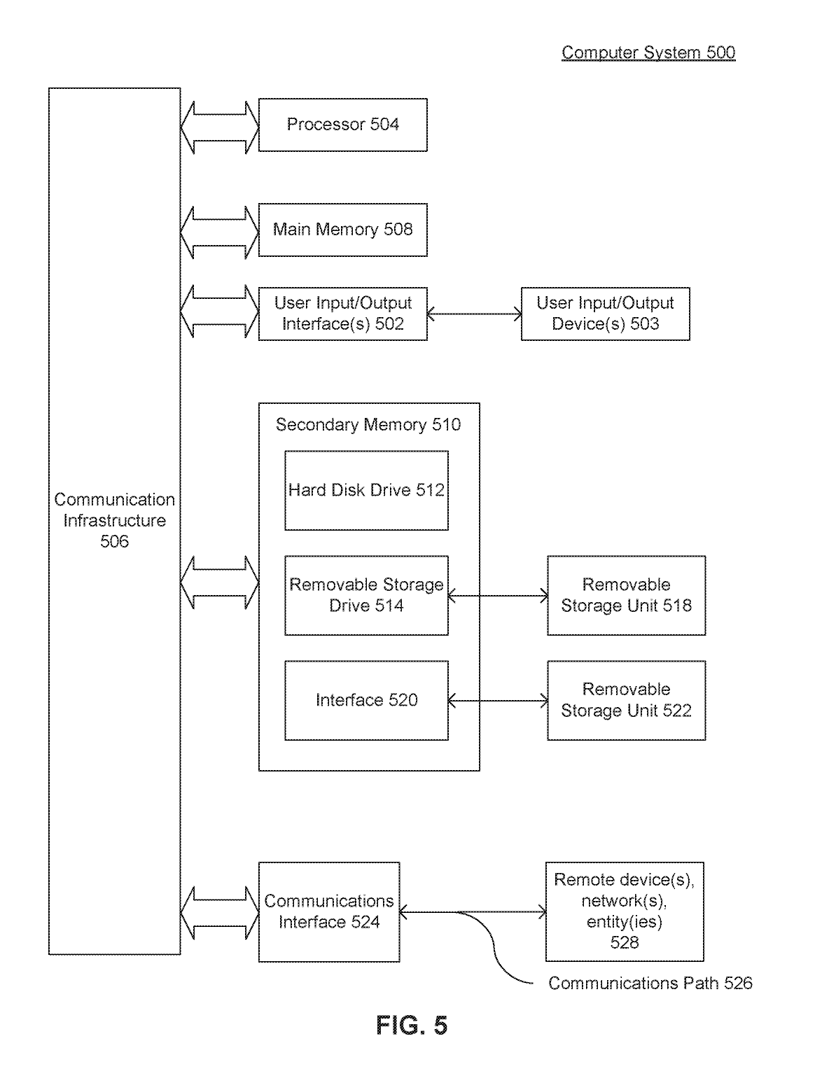

FIG. 5 is an example computing system useful for implementing various embodiments. Various embodiments can be implemented, for example, using one or more well-known computer systems, such as computer system 500. Computer system 500 can be any well-known computer capable of performing the functions described herein, such as computers available from International Business Machines, Apple, Sun, HP, Dell, Sony, Toshiba, etc.

Computer system 500 includes one or more processors (also called central processing units, or CPUs), such as a processor 504. Processor 504 may be connected to a communication infrastructure or bus 506.

One or more processors 504 may each be a graphics processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

Computer system 500 also includes user input/output device(s) 503, such as monitors, keyboards, pointing devices, etc., which communicate with communication infrastructure 506 through user input/output interface(s) 502.

Computer system 500 also includes a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 includes a computer usable or readable storage device having stored thereon computer software (control logic) and/or data. Removable storage unit 518 may be a floppy disk, magnetic tape, compact disk, DVD, optical storage disk, and/or any other computer data storage device. Removable storage drive 514 reads from and/or writes to removable storage unit 518 in a well-known manner.

According to an exemplary embodiment, secondary memory 510 may include other means, instrumentalities, or other approaches for allowing computer programs and/or other instructions and/or data to be accessed by computer system 500. Such means, instrumentalities, or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 500 may further include a communication or network interface 524. Communication interface 524 enables computer system 500 to communicate and interact with any combination of remote devices, remote networks, remote entities, etc. (individually and collectively referenced by reference number 528). For example, communication interface 524 may allow computer system 500 to communicate with remote devices 528 over communications path 526, which may be wired and/or wireless, and which may include any combination of LANs, WANs, the Internet, etc. Control logic and/or data may be transmitted to and from computer system 500 via communication path 526.

In an embodiment, a tangible apparatus or article of manufacture comprising a tangible computer useable or readable medium having control logic (software) stored thereon is also referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), causes such data processing devices to operate as described herein.

Based on the teachings contained in this disclosure, it will be apparent to persons skilled in the relevant art(s) how to make and use the inventions using data processing devices, computer systems and/or computer architectures other than that shown in FIG. 5. In particular, embodiments may operate with software, hardware, and/or operating system implementations other than those described herein.

The breadth and scope of the present inventions should not be limited by any of the above-described embodiments, but should be defined only in accordance with the following claims and their equivalents.

What is claimed is:

1. A call processing system, comprising:
one or more circuits and/or processors; and
a call processing engine, implemented on the one or more circuits and/or processors, the call processing engine comprising:
an authenticator configured to:
receive a request to initiate a call involving a first inmate at a controlled. facility;
authenticate an identity of the first inmate; and
connect the call to a third party outside of the controlled facility;
a tone generator configured to generate a modulated tone encoded with source information of the call; and
a transmitter configured to intermittently transmit the generated tone as part of audio of the call while the call is active.

2. The system of claim 1, further comprising:
a call database that stores call data related to calls processed e call processing engine;
wherein the call processing engine further comprises a data analyzer configured to:
monitor received data of the call to detect a second modulated tone;
extract source information encoded within the second modulated tone;
compare the extracted source information with data stored in the call database; and
determine that the extracted source information corresponds to a second inmate at a second controlled facility.

3. The system of claim 2, wherein the data analyzer is further configured to send an alert to one or more parties in response to determining that the extracted source information corresponds to the second inmate.

4. The system of claim 1, wherein the tone generator is further configured to:
generate a code sequence representing the source information; and
modulate a frequency of the tone to embed the code sequence.

5. The system of claim 4, wherein the code sequence comprises a partitioned sequence of digits that identify the inmate and the controlled facility.

6. The system of claim 4, wherein the code sequence comprises a sequence of digits unique to the call.

7. The system of claim 1, wherein the transmitter is further configured to intermittently transmit the generated tone at random time intervals while the call is active.

8. A method for monitoring communications, comprising:
initiating a call involving a first inmate at a controlled facility;
generating a modulated tone encoded with source information of the call, the source information including information identifying of the first inmate and the first controlled facility;
connecting the call from the first inmate to an outside calling party;
transmitting the generated tone as part of audio of the call in response to connecting the call;

9. The method of claim 8, further comprising:
monitoring received data of the call to detect a second modulated tone;
extracting source information encoded within the second modulated tone; and
determining from the extracted source information whether the second tone corresponds to a second inmate at the first controlled facility or a second controlled facility.

10. The method of claim 9, further comprising alerting one or more parties in response to determining that the second tone corresponds to the second inmate.

11. The method of claim 8, wherein the generating further comprises:
generating a code sequence representing the source information; and
modulating a frequency of the tone to embed the code sequence.

12. The method of claim 11, wherein the code sequence comprises a partitioned sequence of digits that identify the inmate and the controlled facility.

13. The method of claim 11, wherein the code sequence comprises a sequence of digits unique to the call.

14. The method of claim 8, wherein the tone is intermittently transmitted at random time intervals while the call is active.

15. A non-transitory computer-readable storage device having instructions stored thereon that, when executed by at least one computing device, causes the at least one computing device to perform operations comprising:
initiating a call involving an inmate at a controlled facility;
retrieving identifiers corresponding to the inmate and the controlled facility from a call database;
concatenating the inmate identifier and the controlled facility identifier to create a code sequence;
generating a pure tone having a particular carrier frequency;
modulating the frequency of the pure tone to encode the code sequence; and
transmitting the modulated tone as part of audio of the call.

16. The non-transitory computer-readable storage device of claim 15, wherein the concatenating further comprises:
converting the inmate and controlled facility identifiers to binary representations; and
concatenating the binary representations of the inmate and controlled facility identifiers.

17. The non-transitory computer-readable storage device of claim 15, wherein the concatenating further comprises:
transforming inmate identifier into a first fixed length digit sequence;
transforming the controlled facility identifier into a second fixed length digit sequence; and
concatenating the first and second fixed length digit sequences.

18. The non-transitory computer-readable storage device of claim 15, wherein the modulating further comprises:
modulating the frequency of the pure tone within a range of 50 Hz above or below the carrier frequency.

19. The non-transitory computer-readable storage device of claim 15, wherein the modulated tone is transmitted as a short-duration beep.

20. The non-transitory computer-readable storage device of claim 15, wherein the modulated. tone is transmitted simultaneously with notices played during the call;
